(19) United States
(12) Patent Application Publication
(10) Pub. No.: US 2026/0246587 A1
(43) Pub. Date: Aug. 20, 2026

(54) STATIC AND DYNAMIC RATE MATCHING FOR NEW RADIO USER EQUIPMENT

(71) Applicant: Telefonaktiebolaget LM Ericsson (publ), Stockholm (SE)

(72) Inventors: Tomas SVADLING, Hammarö (SE); Saad Naveed AHMED, SUNDBYBERG (SE)

(21) Appl. No.: 19/161,505

(22) PCT Filed: Mar. 16, 2023
(86) PCT No.: PCT/SE2023/050232

§ 371 Date: Sep. 2, 2025

(51) Int. Cl. H04L 5/00; H04W 76/27

(52) U.S. Cl. CPC H04L 5/005; H04L 5/0032; H04L 5/0094; H04W 76/27

(57) ABSTRACT

There is provided techniques for configuring static and dynamic CRS rate matching for NR UEs. The spectrum in which the NR UEs are served at least partly overlaps with the spectrum in which LTE UEs are served. A method is performed by a network node. The method comprises obtaining information of LTE CRS port configuration for an LTE downlink subframe. The method comprises determining, for the NR UEs, configuration for static and dynamic CRS rate matching in the LTE downlink subframe. How to combine the static CRS rate matching with the dynamic CRS rate matching in the LTE downlink subframe is dependent on the obtained information of the LTE CRS port configuration. The method comprises providing the configuration to the NR UEs.

### TECHNICAL FIELD

Embodiments presented herein relate to a method, a network node, a computer program, and a computer program product for configuring static and dynamic cell-specific reference signal rate matching for New Radio user equipment.

### BACKGROUND

NR (New Radio) is the air interface specified for the fifth generation (5G) telecommunications systems according to the third-generation partnership project (3GPP). NR might be regarded as a further development, with enhanced functionality and performance, of the Long-Term Evolution (LTE) air interface.

Mobile network operators that deploy NR typically have access to, or have been allocated, existing frequency spectrum on multiple frequency bands where LTE signalling is currently deployed. Initially, the fraction of NR capable user equipment (UEs) might be limited compared to LTE capable user equipment and therefore a large part of the existing frequency spectrum might still need to be allocated for LTE signalling.

There are several architecture options for how to deploy NR together with LTE.

One option is to use LTE as the main air interface whilst NR is added using dual connectivity in non-standalone mode. With dual connectivity, both the LTE air interface and the NR air interface can be used in parallel for data transmission (and reception). In the downlink (i.e., in the direction from a radio access network node on the network side towards UEs on the user side) the data transmission is split at the Packet Data Convergence Protocol (PDCP) layer and can use either one of the air interfaces (i.e., LTE or NR) or both. In uplink (i.e., in the direction from the UE on the user side towards a radio access network node on the network side) the data received from the two air interfaces are combined in the PDCP layer at the radio access network node.

To have an efficient frequency spectrum utilization, it is possible to overlay an NR carrier in the same frequency spectrum as an LTE carrier. This is made possible by flexible locations of control channels and signals, and by NR rate matching around LTE reference signals, such as cell-specific reference signal (CRS), channel state information reference signal (CSI-RS), and synchronization signals (such as primary synchronization signal (PSS), secondary synchronization signal (SSS)), and physical broadcast channel (PBCH) that are transmitted in an LTE carrier.

A side effect of dynamically sharing the spectrum using CRS rate matching is that the NR Physical Downlink Control Channel (PDCCH) becomes constrained to only the symbols where CRS does not exist. This significantly caps the number of simultaneous scheduled UEs and hampers the efficient use of the spectrum.

Hence, there is still a need for improved joint downlink NR and LTE transmissions.

### SUMMARY

An object of embodiments herein is to provide efficient joint downlink NR and LTE transmission that does not suffer from the issues noted above, or at least where the issues noted above are mitigated or reduced.

According to a first aspect there is presented a method for configuring static and dynamic CRS rate matching for NR UEs. The spectrum in which the NR UEs are served at least partly overlaps with the spectrum in which LTE UEs are served. The method is performed by a network node. The method comprises obtaining information of LTE CRS port configuration for an LTE downlink subframe. The method comprises determining, for the NR UEs, configuration for static and dynamic CRS rate matching in the LTE downlink subframe. How to combine the static CRS rate matching with the dynamic CRS rate matching in the LTE downlink subframe is dependent on the obtained information of the LTE CRS port configuration. The method comprises providing the configuration to the NR UEs.

According to a second aspect there is presented a network node for configuring static and dynamic CRS rate matching for NR UEs. The spectrum in which the NR UEs are served at least partly overlaps with the spectrum in which LTE UEs are served. The network node comprises processing circuitry. The processing circuitry is configured to cause the network node to obtain information of LTE CRS port configuration for an LTE downlink subframe. The processing circuitry is configured to cause the network node to determine, for the NR UEs, configuration for static and dynamic CRS rate matching in the LTE downlink subframe. How to combine the static CRS rate matching with the dynamic CRS rate matching in the LTE downlink subframe is dependent on the obtained information of the LTE CRS port configuration. The processing circuitry is configured to cause the network node to provide the configuration to the NR UEs.

According to a third aspect there is presented a network node for configuring static and dynamic CRS rate matching for NR UEs. The spectrum in which the NR UEs are served at least partly overlaps with the spectrum in which LTE UEs are served. The network node comprises an obtain module configured to obtain information of LTE CRS port configuration for an LTE downlink subframe. The network node comprises a determine module configured to determine, for the NR UEs, configuration for static and dynamic CRS rate matching in the LTE downlink subframe. How to combine the static CRS rate matching with the dynamic CRS rate matching in the LTE downlink subframe is dependent on the obtained information of the LTE CRS port configuration. The network node comprises a provide module configured to provide the configuration to the NR UEs.

According to a fourth aspect there is presented a computer program for configuring static and dynamic CRS rate matching for NR UEs. The spectrum in which the NR UEs are served at least partly overlaps with the spectrum in which LTE UEs are served. The computer program comprises computer code which, when run on processing circuitry of a network node, causes the network node to perform actions. One action comprises the network node to obtain information of LTE CRS port configuration for an LTE downlink subframe. One action comprises the network node to determine, for the NR UEs, configuration for static and dynamic CRS rate matching in the LTE downlink subframe. How to combine the static CRS rate matching with the dynamic CRS rate matching in the LTE downlink subframe is dependent on the obtained information of the LTE CRS port configuration. One action comprises the network node to provide the configuration to the NR UEs.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide efficient joint downlink NR and LTE transmission.

Advantageously, these aspects provide joint downlink NR and LTE transmission that does not suffer from the issues noted above.

Advantageously, combining static RM for LTE CRS Port 0 with dynamically controlled RM for the remaining LTE CRS ports reduce the need for zero-power channel state information reference signal (ZP-CSI-RS) configured resource elements (REs) and will fit in one ZP-CSI-RS-ResourcesSet of 16 symbols.

Advantageously, all LTE CRS REs can be opportunistically used for NR UEs except CRS Port 0 at low LTE load or when only one spatial layer is used by the LTE UEs.

Advantageously, when LTE CRS is configured with two ports, when there is need to transmit CRS over both ports, the CRS can be enabled on the second port (Port 1) in the whole LTE carrier. Dynamic RM can be used for NR UEs to RM the second port's CRS REs. This allows LTE UEs to operate with both spatial layers with full efficiency.

Advantageously, when LTE CRS is configured with four ports, with only the first CRS port (Port 0) configured with static RM, when there is need to transmit CRS over all ports, the CRS can be enabled on the second port (Port 1), third port (Port 2), and fourth port (Port 3) in the upper or lower part of the LTE carrier. Dynamic RM can be used for NR UEs to RM the second, third, and fourth ports' CRS REs. This allows the LTE UEs to operate with all four spatial layers with improved efficiency.

Advantageously, when LTE CRS is configured with four ports, with the first and second CRS ports configured with static RM, when there is need to transmit CRS over all ports, the CRS can be enabled on the third port (Port 2) and the fourth port (Port 3) in the upper, lower, or full part of the LTE carrier. Dynamic RM can be used for NR UEs to RM the third, and fourth ports' CRS REs. This allows LTE UEs to operate with all spatial four layers with full efficiency.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communications network according to embodiments;

FIG. 2 illustrates examples of LTE CRS port configurations according to embodiments;

FIG. 3 is a flowchart of methods according to embodiments;

FIG. 4 is a block diagram of a network node according to an embodiment;

FIG. 5 is a signaling diagram of a method according to an embodiment;

FIG. 6 is a flowchart of a method according to an embodiment;

FIG. 7 is a flowchart of a method according to an embodiment;

FIG. 8 is a schematic diagram showing functional units of a network node according to an embodiment;

FIG. 9 is a schematic diagram showing functional modules of a network node according to an embodiment; and

FIG. 10 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

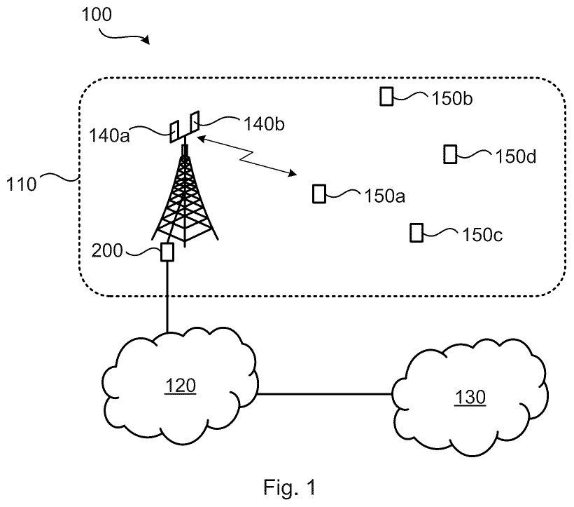

FIG. 1 is a schematic diagram illustrating a communications network 100 where embodiments presented herein can be applied. The communications network 100 comprises a network node 200 configured to provide network access to user equipment, as represented by user equipment 150a, 150b, 150c, 150d, in a radio access network 110. The radio access network 110 is operatively connected to a core network 120. The core network 120 is in turn operatively connected to a service network 130, such as the Internet. The user equipment 150a, 150b, 150c, 150d are thereby enabled to, via the network node 200, access services of, and exchange data with, the service network 130. Some of the user equipment might be configured to communicate with the network node 200 using only LTE signalling, some of the user equipment might be configured to communicate with the network node 200 only using NR signalling, and some of the user equipment might be configured to communicate with the network node 200 using both LTE signalling and NR signalling. User equipment 150c, 150d configured to communicate with the network node 200 using LTE signalling are hereinafter denoted LTE user equipment. User equipment 150a, 150b configured to communicate with the network node 200 using NR signalling are hereinafter denoted NR user equipment.

The network node 200 comprises, is collocated with, is integrated with, or is in operational communications with, an antenna system comprising co-sited antenna arrays 140a, 140b. Each of the antenna arrays 140a, 140b might comprise a plurality of individual antennas, or antenna elements. In some implementations, one antennas antenna array 140b might be configured for LTE signalling whereas the other antennas antenna array 140a might be configured for NR signalling. In other implementations, both antenna arrays 140a, 140b are configured for both LTE signalling and NR signalling.

Examples of network nodes 200 are radio access network nodes, radio base stations, base transceiver stations, Node Bs, evolved Node Bs, gNBs, access points, access nodes, transmission and reception points, and integrated access and backhaul nodes. Examples of user equipment 150a, 150b, 150c, 150d are terminal devices, wireless devices, mobile stations, mobile phones, handsets, wireless local loop phones, smartphones, laptop computers, tablet computers, network equipped sensors, network equipped vehicles, and so-called Internet of Things devices.

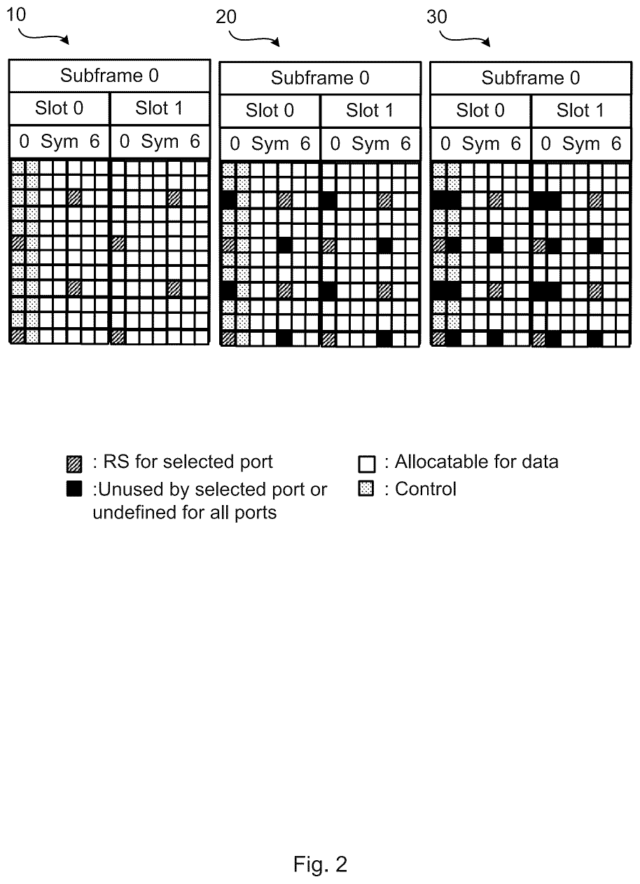

FIG. 2 illustrates time/frequency resources in time/frequency resource grids for different examples of (downlink) LTE CRS port configurations 10, 20, 30. Each resource grid is illustrated for one physical resource block (PRB) and thus spans one subframe in length and 12 subcarriers in frequency. The subframe is time-wise divided into two slots (denoted “Slot 0” and “Slot 1” respectively), where each slot is composed of 7 orthogonal frequency-division multiplexing (OFDM) symbols, and where the two slots make up one PRB. In total, each PRB thus consists of 12·7·2=168 resource elements (REs). As schematically illustrated, each RE can be used either for a reference signal (RS), such as an CRS, for control information, for data, or be unused or undefined. The LTE CRS port configuration 10 is valid for transmission on a single port (Port 0). The LTE CRS port configuration 20 is valid for transmission on two ports (Port 0 and Port 1). The LTE CRS port configuration 30 is valid for transmission on four ports (Port 0, Port 1, Port 2, and Port 3).

As noted above there is still a need for improved joint downlink NR and LTE transmissions.

The embodiments disclosed herein therefore relate to techniques for configuring static and dynamic CRS RM for NR UEs 150a, 150b. In order to obtain such techniques there is provided a network node 200, a method performed by the network node 200, a computer program product comprising code, for example in the form of a computer program, that when run on a network node 200, causes the network node 200 to perform the method.

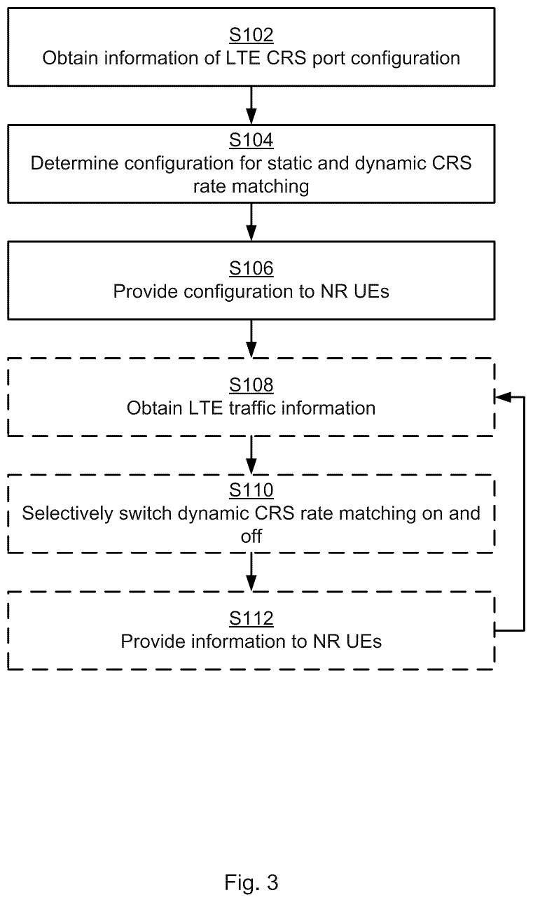

FIG. 3 is a flowchart illustrating embodiments of methods for configuring static and dynamic CRS RM for NR UEs 150a, 150b. The spectrum in which the NR UEs 150a, 150b are served at least partly overlaps with the spectrum in which LTE UEs 150c, 150d are served. The methods are performed by the network node 200. The methods are advantageously provided as computer programs 1020.

At least some of the embodiments are based on the coexistence of static and dynamic RM and the combination of these. In which way the static and dynamic RM are combined depends on LTE information (in terms of CRS port configuration).

S102: The network node 200 obtains information of LTE CRS port configuration 10, 20, 30 for an LTE downlink subframe.

S104: The network node 200 determines, for the NR UEs 150a, 150b, configuration for static and dynamic CRS RM in the LTE downlink subframe. How to combine the static CRS RM with the dynamic CRS RM in the LTE downlink subframe is dependent on the obtained information of the LTE CRS port configuration 10, 20, 30.

Once it has been decided how the static and dynamic RM are combined, this information is communicated in the NR cell to the NR UEs.

S106: The network node 200 provides the configuration to the NR UEs 150a, 150b.

Embodiments relating to further details of configuring static and dynamic CRS RM for NR UEs 150a, 150b as performed by the network node 200 will now be disclosed with continued reference to FIG. 3.

In some embodiments, the configuration is provided to the NR UEs 150a, 150b as part of a RRC configuration process as the NR UEs 150a, 150b establish network connection.

How the static and dynamic RM are combined could be updated over time, based on further information from the LTE cell. In some aspects, depending on LTE UEs' 150c, 150d traffic, dynamic RM can be switched on or off. Then the NR UEs are also made aware of how the combination of static and dynamic RM has been updated. This information might be conveyed using downlink control information (DCI). Hence, in some embodiments, the network node 200 is configured to perform (optional) steps S108, S110, and S112.

S108: The network node 200 obtains LTE traffic information.

S110: The network node 200 selectively switches the dynamic CRS RM on and off depending on the LTE traffic information.

S112: The network node 200 provides, as part of DCI, information of whether the dynamic CRS RM has been switched on or off to the NR UEs 150a, 150b.

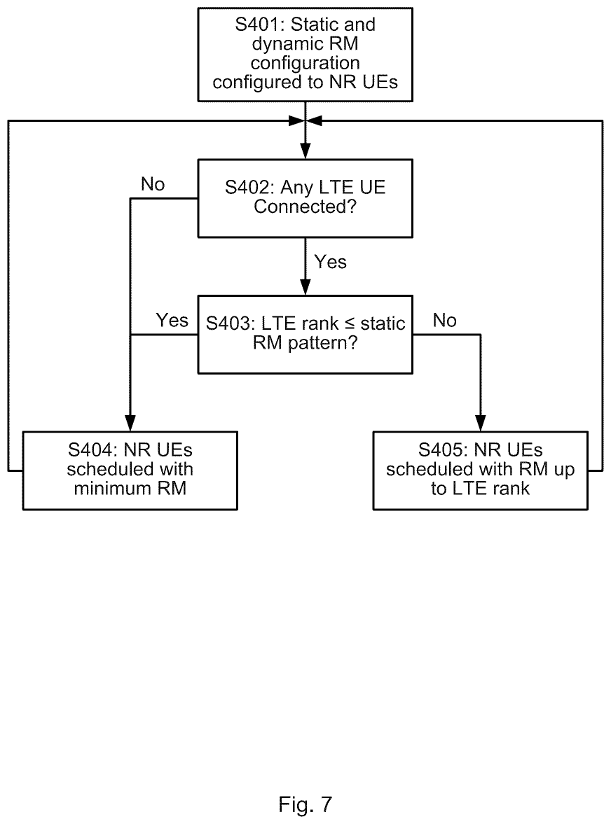

There can be different ways for the network node 200 to determine when to use dynamic RM, when to use static RM, and when to use a combination of dynamic RM and static RM. Embodiments relating thereto will be disclosed next. Further aspects of this will also be disclosed below with reference to the flowchart of FIG. 7.

In some aspects, if the rank of each LTE UE 150c, 150d is less than or equal to the static RM pattern corresponding to the number of ports, then the NR UEs 150a, 150b can be scheduled with only static RM. That is, in some embodiments, the LTE traffic information pertains to spatial rank reported by each LTE UE 150c, 150d, and the dynamic CRS RM is switched off unless a highest reported spatial rank is higher than the corresponding number of ports used for the static CRS RM.

In some aspects, the NR UEs 150a, 150b are scheduled with RM up to the highest rank reported by any LTE UE 150c, 150d. That is, in some embodiments, when dynamic CRS RM is switched on, the NR UEs 150a, 150b are scheduled with dynamic CRS RM that corresponds to the highest reported spatial rank reported by the LTE UEs 150c, 150d.

In some aspects, rateMatchingLTE-CRS as defined in 3GPP TR 38.822 “NR; User Equipment (UE) feature list”, version 16.4.0, will be used for the static RM. That is, in some embodiments, rateMatchingLTE-CRS is used for the static CRS RM.

In some aspects, static CRS RM is used for LTE CRS Port 0. That is, in some embodiments, according to the LTE CRS port configuration 10, 20, 30, the CRS is transmitted on LTE CRS ports, and the static CRS RM is used only for LTE CRS Port 0, or for both LTE CRS Port 0 and LTE CRS Port 1

In some aspects, ZP-CSI-RS RM is used for the dynamic RM. That is, in some embodiments, ZP-CSI-RS is used for the dynamic CRS RM. ZP-CSI-RS can be considered as special empty resource elements, used mostly for interference measurement. It defines a set of REs which do not contain any transmission for the UE. These REs may however contain transmissions for other UEs.

In some aspects, dynamic control RM is used for the remaining LTE CRS Ports. That is, in some embodiments, according to the LTE CRS port configuration 10, 20, 30, the CRS is transmitted on LTE CRS ports, and the dynamic CRS RM is used for all ports except LTE CRS Port 0 where the static CRS RM is used.

In general terms, the NR cell might aim to use as much dynamic RM as possible to minimize the need of static RM, since static RM always contribute to NR overhead whilst dynamic RM only contributes to the NR overhead when dynamic RM is needed. The limit of a maximum of 16 ZP-CSI-RS REs per ZP-CSI-RS resource set is what decides how much dynamic RM is possible. For example, for 1-port transmission, no static RM is needed, whilst for 2-port transmission, 1-port static RM still be needed if the full carrier should be covered.

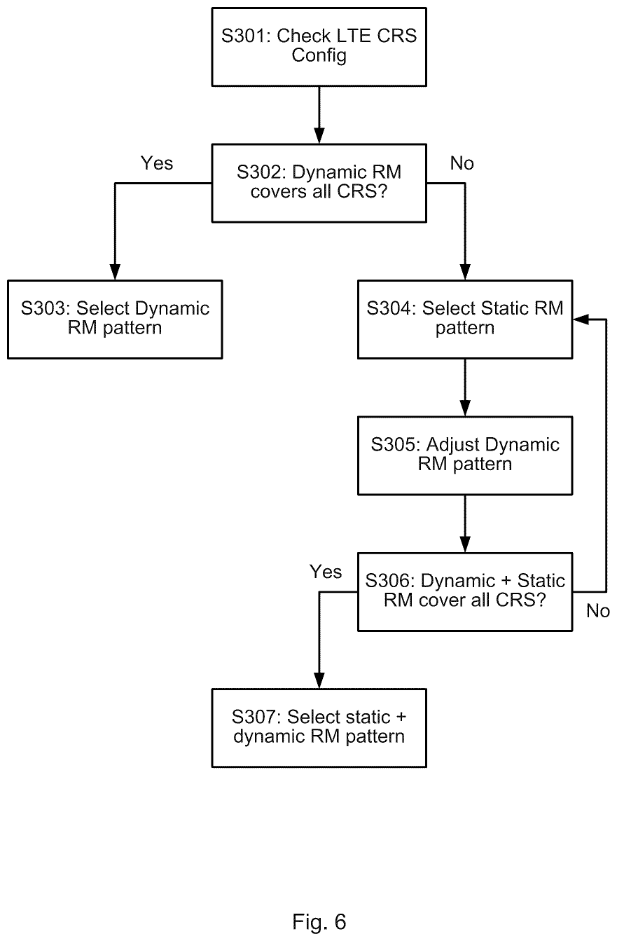

There can be different ways for the network node 200 to determine how to combine the static CRS RM with the dynamic CRS RM in the LTE downlink subframe. Embodiments relating thereto will be disclosed next. Further aspects of this will also be disclosed below with reference to the flowchart of FIG. 6.

In some embodiments, how to combine the static CRS RM with the dynamic CRS RM in the LTE downlink subframe comprises selecting only a pattern for dynamic CRS RM in case dynamic CRS RM can cover all LTE CRSs, and else selecting a pattern for both static CRS RM and dynamic CRS RM.

In some embodiments, selecting the pattern for both static CRS RM and dynamic CRS RM comprises iteratively selecting a pattern for static CRS RM, and adjusting a pattern for dynamic CRS RM until the pattern for both static CRS RM and dynamic CRS RM covers all the LTE CRSs.

Embodiments where, according to the LTE CRS port configuration 10, the CRS is transmitted on only CRS Port 0 in each LTE downlink subframe will be disclosed next.

In some aspects, no static RM is configured, and the ZP-CSI-RS-ResourcesSets can be configured with CRS Port 0 RM in 1, 2, 3 or 4 symbols (i.e., symbols 0, 4, 7, 11) in the NR PDSCH area. That is, in some embodiments, when according to the LTE CRS port configuration 10, the CRS is transmitted on only CRS Port 0 in each LTE downlink subframe, then the static CRS RM is without resource elements, and the dynamic CRS RM has resource elements that match the resource elements on which the LTE CRS is transmitted in any, or any combination of, symbols 0, 4, 7, 11 in the LTE downlink subframe. That the static CRS RM is without resource elements can be regarded as that static CRS matching is not configured.

Examples of this embodiment excluding symbol 0 are listed next.

One ZP-CSI-RS-ResourcesSet with 6 ZP-CSI-RS resources to RM around CRS Port 0 in symbols 4, 7, 11 in the upper part of the LTE carrier.

One ZP-CSI-RS-ResourcesSet with 6 ZP-CSI-RS resources to RM around CRS Port 0 in symbols 4, 7, 11 in the lower part of the LTE carrier.

One ZP-CSI-RS-ResourcesSet with 2.6 ZP-CSI-RS resources to RM around CRS Port 0 in symbols 4, 7, 11 in the upper and lower part of the LTE carrier.

Examples of this embodiment including symbol 0 are listed next.

One ZP-CSI-RS-ResourcesSet with 8 ZP-CSI-RS resources to RM around CRS Port 0 in symbols 0, 4, 7, 11 in the upper part of the LTE carrier.

One ZP-CSI-RS-ResourcesSet with 8 ZP-CSI-RS resources to RM around CRS Port 0 in symbols 0, 4, 7, 11 in the lower part of the LTE carrier.

One ZP-CSI-RS-ResourcesSet with 2.8 ZP-CSI-RS resources to RM around CRS Port 0 in symbols 0, 4, 7, 11 in the upper and lower part of the LTE carrier.

Embodiments where, according to the LTE CRS port configuration 20, the CRS is transmitted on only CRS Port 0 or on both CRS Port 0 and CRS Port 1 in the LTE downlink subframe will be disclosed next.

In some aspects, no static RM configured, and ZP-CSI-RS-ResourcesSets can be configured with CRS Port 0 and 1 RM in 1, 2, 3 or 4 symbols (i.e., symbols 0, 4, 7, 11) in the NR PDSCH area. That is, in some embodiments, the static CRS RM is without resource elements, and the dynamic CRS RM has resource elements that match the resource elements on which the LTE CRS is transmitted for both CRS Port 0 and CRS Port 1 in any, or any combination of, symbols 0, 4, 7, 11 in each LTE downlink subframe. That the static CRS RM is without resource elements can be regarded as that static CRS matching is not configured.

Examples of this embodiment excluding symbol 0 are listed next.

One ZP-CSI-RS-ResourcesSet with 12 ZP-CSI-RS resources to RM around CRS Port 0 and 1 in the upper part of the LTE carrier.

One ZP-CSI-RS-ResourcesSet with 12 ZP-CSI-RS resources to RM around CRS Port 0 and Port 1 in the lower part of the LTE carrier.

Examples of this embodiment including symbol 0 are listed next.

One ZP-CSI-RS-ResourcesSet with 16 ZP-CSI-RS resources to RM around CRS Port 0 and Port 1 in the upper part of the LTE carrier.

One ZP-CSI-RS-ResourcesSet with 16 ZP-CSI-RS resources to RM around CRS Port 0 and Port 1 in the lower part of the LTE carrier.

In some aspects, static rateMatchingLTE-CRS RM is configured for Port 0 and ZP-CSI-RS-ResourcesSets can be configured with CRS Port 1 RM in 1, 2, 3 or 4 symbols (i.e., symbols 0, 4, 7, 11) in the NR PDSCH area. That is, in some embodiments, the static CRS RM has resource elements that match the resource elements on which the LTE CRS is transmitted for CRS Port 0 in any, or any combination of, symbols 0, 4, 7, 11 in the LTE downlink subframe, and the dynamic CRS RM has resource elements that match the resource elements on which the LTE CRS is transmitted for CRS Port 1 in any, or any combination of, symbols 0, 4, 7, 11 in the LTE downlink subframe.

Examples of this embodiment excluding symbol 0 are listed next.

One ZP-CSI-RS-ResourcesSet with 6 ZP-CSI-RS resources to RM around CRS Port 1 in symbols 4, 7, 11 in the upper part of the LTE carrier.

One ZP-CSI-RS-ResourcesSet with 6 ZP-CSI-RS resources to RM around CRS Port 1 in symbols 4, 7, 11 in the lower part of the LTE carrier.

One ZP-CSI-RS-ResourcesSet with 2.6 ZP-CSI-RS resources to RM around CRS Port 1 in symbols 4, 7, 11 in the upper and lower part of the LTE carrier.

Examples of this embodiment including symbol 0 are listed next.

One ZP-CSI-RS-ResourcesSet with 8 ZP-CSI-RS resources to RM around CRS Port 1 in symbols 0, 4, 7, 11 in the upper part of the LTE carrier.

One ZP-CSI-RS-ResourcesSet with 8 ZP-CSI-RS resources to RM around CRS Port 1 in symbols 0, 4, 7, 11 in the lower part of the LTE carrier.

One ZP-CSI-RS-ResourcesSet with 2.8 ZP-CSI-RS resources to RM around CRS Port 1 in symbols 0, 4, 7, 11 in the upper and lower part of the LTE carrier.

Embodiments where, according to the LTE CRS port configuration 30, the CRS is transmitted on only CRS Port 0, on only CRS Port 0 and one of CRS Port 1, CRS Port 2, CRS Port 3, or on only CRS Port 0, and two of CRS Port 1, CRS Port 2, CRS Port 3, or on all CRS ports in the LTE downlink subframe will be disclosed next.

In some aspects, no static RM configured, and ZP-CSI-RS-ResourcesSets can be configured with CRS Port 0, 1, 2 and 3 RM in 1, 2, 3, 4, 5 or 6 symbols (i.e., symbols 0, 1, 4, 7, 8, 11) in the NR PDSCH area. That is, in some embodiments, the static CRS RM is without resource elements, and the dynamic CRS RM has resource elements that match the resource elements on which the LTE CRS is transmitted for both CRS Port 0, CRS Port 1, CRS Port 2 and CRS Port 3 in any, or any combination of, symbols 0, 1, 4, 7, 8, 11 in each LTE downlink subframe. Port 1 can only be in any of symbols 0, 4, 7, 11 whereas Ports 2 and 3 can only be in symbols 1 and 8. That the static CRS RM is without resource elements can be regarded as that static CRS matching is not configured.

Examples of this embodiment excluding symbols 0 and 1 are listed next.

One ZP-CSI-RS-ResourcesSet with 16 ZP-CSI-RS resources to RM around CRS Ports 0, 1, 2 and 3 in symbols 4, 7, 8, 11 in the upper part of the LTE carrier.

One ZP-CSI-RS-ResourcesSet with 16 ZP-CSI-RS resources to RM around CRS Ports 0, 1, 2 and 3 in symbols 4, 7, 8, 11 in the lower part of the LTE carrier.

In some aspects, static rateMatchingLTE-CRS RM is configured for Port 0 and ZP-CSI-RS-ResourcesSets can be configured with CRS Port 1, 2 and 3 RM in 1, 2, 3, 4, 5 or 6 symbols (i.e., symbols 0, 1, 4, 7, 8, 11) in the NR PDSCH area. That is, in some embodiments, the static CRS RM has resource elements that match the resource elements on which the LTE CRS is transmitted for CRS Port 0 in any, or any combination of, symbols 0, 4, 7, 11 in the LTE downlink subframe, and the dynamic CRS RM has resource elements that match the resource elements on which the LTE CRS is transmitted for CRS Port 1, CRS Port 2 and CRS Port 3 in any, or any combination of, symbols 0, 1, 4, 7, 8, 11 in the LTE downlink subframes. Port 1 can only be in any of symbols 0, 4, 7, 11 whereas Ports 2 and 3 can only be in symbols 1 and 8.

Examples of this embodiment excluding symbols 0 and 1 are listed next.

One ZP-CSI-RS-ResourcesSet with 10 ZP-CSI-RS resources to RM around CRS Ports 1, 2 and 3 in symbols 1, 4, 7, 8, 11 in the upper part of the LTE carrier.

One ZP-CSI-RS-ResourcesSet with 10 ZP-CSI-RS resources to RM around CRS Ports 1, 2 and 3 in symbols 1, 4, 7, 8, 11 in the lower part of the LTE carrier.

Examples of this embodiment excluding symbol 0 are listed next.

One ZP-CSI-RS-ResourcesSet with 14 ZP-CSI-RS resources to RM around CRS Ports 1, 2 and 3 in symbols 1, 4, 7, 8, 11 in the upper part of the LTE carrier.

One ZP-CSI-RS-ResourcesSet with 14 ZP-CSI-RS resources to RM around CRS Ports 1, 2 and 3 in symbols 1, 4, 7, 8, 11 in the lower part of the LTE carrier.

Examples of this embodiment including symbol 0 are listed next.

One ZP-CSI-RS-ResourcesSet with 16 ZP-CSI-RS resources to RM around CRS Ports 1, 2 and 3 in symbols 0, 1, 4, 7, 8, 11 in the upper part of the LTE carrier.

One ZP-CSI-RS-ResourcesSet with 16 ZP-CSI-RS resources to RM around CRS Ports 1, 2 and 3 in symbols 0, 1, 4, 7, 8, 11 in the lower part of the LTE carrier.

In some aspects, static rateMatchingLTE-CRS RM is configured for Ports 0 and 1, and ZP-CSI-RS-ResourcesSets can be configured with CRS Port 2 and 3 RM in 1 or 2 symbols (i.e., symbols 1, 8) in the NR PDSCH area. That is, in some embodiments, the static CRS RM has resource elements that match the resource elements on which the LTE CRS is transmitted for both CRS Port 0 and CRS Port 1 in any, or any combination of, symbols 0, 4, 7, 11 in the LTE downlink subframes, and the dynamic CRS RM has resource elements that match the resource elements on which the LTE CRS is transmitted for both CRS Port 2 and CRS Port 3 in any, or any combination of, symbols 1, 8 in the LTE downlink subframes.

Examples of this embodiment excluding symbols 0 and 1 are listed next.

One ZP-CSI-RS-ResourcesSet with 4 ZP-CSI-RS resources to RM around CRS Ports 3 and 4 in symbol 8 in the upper part of the LTE carrier.

One ZP-CSI-RS-ResourcesSet with 4 ZP-CSI-RS resources to RM around CRS Ports 3 and 4 in symbol 8 in the lower part of the LTE carrier.

One ZP-CSI-RS-ResourcesSet with 8 ZP-CSI-RS resources to RM around CRS Ports 3 and 4 in symbol 8 in the upper and lower part of the LTE carrier.

Examples of this embodiment excluding symbol 0 are listed next.

One ZP-CSI-RS-ResourcesSet with 8 ZP-CSI-RS resources to RM around CRS Ports 3 and 4 in symbols 1 and 8 in the upper part of the LTE carrier.

One ZP-CSI-RS-ResourcesSet with 8 ZP-CSI-RS resources to RM around CRS Ports 3 and 4 in symbols 1 and 8 in the lower part of the LTE carrier.

One ZP-CSI-RS-ResourcesSet with 16 ZP-CSI-RS resources to RM around CRS Ports 3 and 4 in symbols 1 and 8 in the upper and lower part of the LTE carrier.

Examples of this embodiment including symbol 0 are listed next.

One ZP-CSI-RS-ResourcesSet with 8 ZP-CSI-RS resources to RM around CRS Ports 3 and 4 in symbols 1 and 8 in the upper part of the LTE carrier.

One ZP-CSI-RS-ResourcesSet with 8 ZP-CSI-RS resources to RM around CRS Ports 3 and 4 in symbols 1 and 8 in the lower part ofthe LTE carrier.

One ZP-CSI-RS-ResourcesSet with 16 ZP-CSI-RS resources to RM around CRS Ports 3 and 4 in symbols 1 and 8 in the upper and lower part of the LTE carrier.

Examples of configurations for static and dynamic CRS RM are summarized in Table 1.

TABLE 1
Example configurations for static and dynamic CRS RM

| | | | | #REs for | | |
|---|---|---|---|---|---|---|
| | | | | full | | |
| LTE | | | | bandwidth | Without | With |
| CRS | NR | CRS | #CRS | Dynamic | Static | Static |
| Ports | PDSCH | symbols | REs | RM | RM | RM |
| 1 | Excludes | 4, 7, 11 | 6 | 12 | N/A | N/A |
| | Sym 0 | | | | | |
| | Includes | 0, 4, 7, | 8 | 16 | N/A | N/A |
| | Sym 0 | 11 | | | | |
| 2 | Excludes | 4, 7, 11 | 12 | 24 | 12 | CRS RM |
| | Sym 0 | | | | Dynamic | Port 0: 6 |
| | | | | | REs in | REs |
| | | | | | Half BW | 12 |
| | | | | | | Dynamic |
| | | | | | | REs in |
| | | | | | | Full BW |
| | Includes | 0, 4, 7, | 16 | 32 | 16 | CRS RM |
| | Sym 0 | 11 | | | Dynamic | Port 0: 8 |
| | | | | | REs in | REs |
| | | | | | Half BW | 16 |
| | | | | | | Dynamic |
| | | | | | | REs in |
| | | | | | | Full BW |
| 4 | Excludes | 4, 7, 8, | 16 | 32 | 16 | CRS RM |
| | Sym 0 | 11 | | | Dynamic | Port 0: 6 |
| | and 1 | | | | REs in | REs |
| | | | | | Half BW | 10 |
| | | | | | | Dynamic |
| | | | | | | REs in |
| | | | | | | Half BW |
| | | | | | | CRS RM |
| | | | | | | Ports 0 |
| | | | | | | and 1: 12 |
| | | | | | | REs |
| | | | | | | 8 Dynamic |
| | | | | | | REs in |
| | | | | | | Full BW |
| | Excludes | 1, 4, 7, | 20 | 40 | N/A | CRS RM |
| | Sym 0 | 8, 11 | | | | Port 0: 6 |
| | | | | | | REs |
| | | | | | | 14 |
| | | | | | | Dynamic |
| | | | | | | REs in |
| | | | | | | Half BW |
| | | | | | | CRS RM |
| | | | | | | Ports 0 |
| | | | | | | and 1: 12 |
| | | | | | | REs |
| | | | | | | 16 |
| | | | | | | Dynamic |
| | | | | | | REs in |
| | | | | | | Full BW |
| | Includes | 0, 1, 4, | 24 | 48 | N/A | CRS RM |
| | Sym 0 | 7, 8, 11 | | | | Port 0: 8 |
| | | | | | | REs |
| | | | | | | 16 |
| | | | | | | Dynamic |
| | | | | | | REs in |
| | | | | | | Half BW |
| | | | | | | CRS RM |
| | | | | | | Ports 0 |
| | | | | | | and 1: 16 |
| | | | | | | REs |
| | | | | | | 16 |
| | | | | | | Dynamic |
| | | | | | | REs in |
| | | | | | | Full BW |

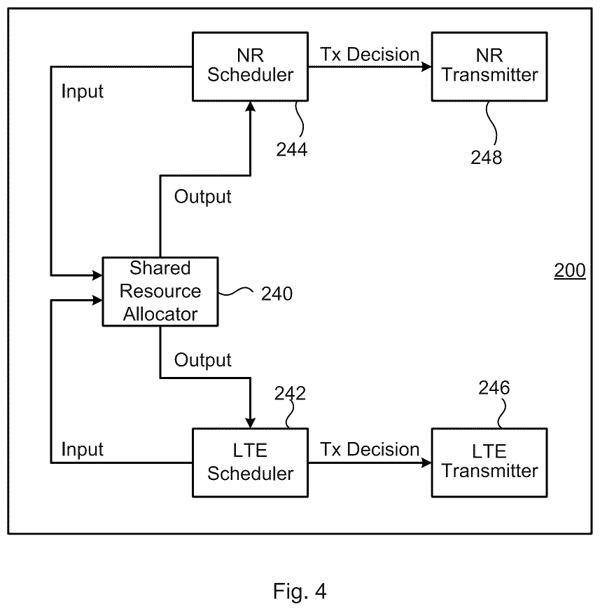

FIG. 4 schematically illustrates a block diagram of a network node 200 having a shared resource allocator 240, an LTE scheduler 242, and an NR scheduler 244, together with an LTE transmitter 246 and an NR transmitter 248. The LTE transmitter 246 might comprise, or be operatively connected to, at least antenna array 140b. The NR transmitter 248 might comprise, or be operatively connected to, at least antenna array 140a. The shared resource allocator 240 is configured to, based on input from the LTE scheduler 242 and the NR scheduler 244 take a decision in terms of determining, for the NR UEs 150a, 150b, configuration for static and dynamic CRS RM in the LTE downlink subframe, as in step S104. Transmission of the LTE downlink subframe is initiated by the shared resource allocator 240 providing output to the LTE scheduler 242 and the NR scheduler 244. The output to the LTE scheduler 242 is defined by a scheduling decision for the LTE UEs. The output to the NR scheduler 244 is defined by the information in step S106. The LTE scheduler 242 is configured to, based on the output received from the shared resource allocator 240, schedule the LTE transmission and initiate transmission of the LTE transmission from the LTE transmitter 246. The NR scheduler 244 is configured to, based on the output received from the shared resource allocator 240, schedule NR transmission and initiate transmission of the NR transmission from the NR transmitter 248.

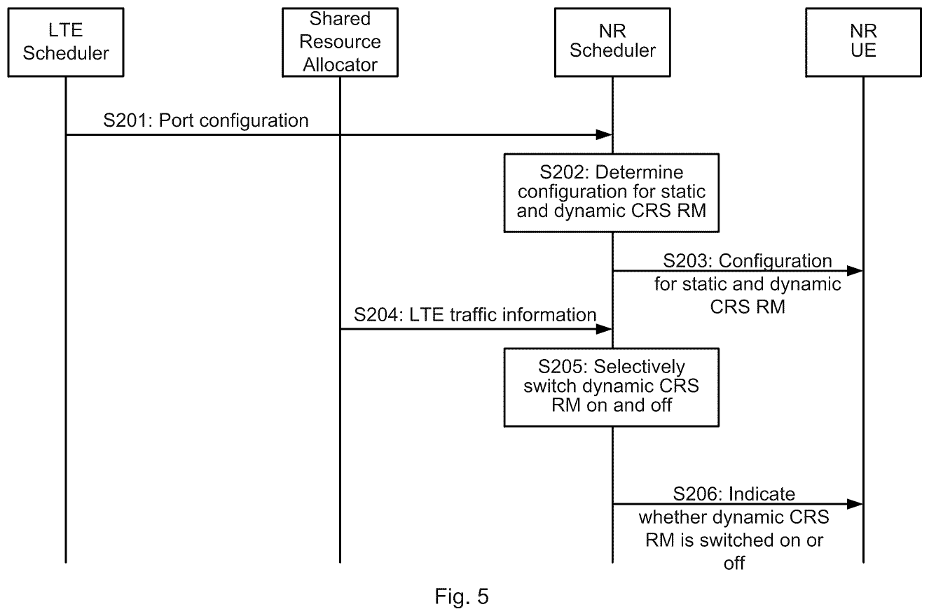

Reference is next made to the signalling diagram of FIG. 5 in which one embodiment for configuring static and dynamic CRS rate matching for NR UEs is illustrated.

S201: The LTE scheduler communicates its CRS port configuration to the NR scheduler.

S202: Based on the received LTE CRS port configuration, the NR scheduler determines, for the NR UEs 150a, 150b, configuration for static and dynamic CRS RM in the LTE downlink subframe. How to combine the static CRS RM with the dynamic CRS RM in the LTE downlink subframe is dependent on the obtained information of the LTE CRS port configuration. An example of how the network node 200 might determine how to combine the static CRS RM with the dynamic CRS RM in the LTE downlink subframe is disclosed in the flowchart of FIG. 6. An example of how the network node 200 might determine when to use dynamic RM, when to use static RM, and when to use a combination of dynamic RM and static RM is disclosed in the flowchart of FIG. 7.

S203: When an NR UE establishes network connection, the NR UE is configured with configuration for static and dynamic CRS RM as part of the RRC configuration process.

Depending on LTE UEs' traffic, dynamic RM around the CRS can be switched on or off with DCI.

S204: The shared resource allocator provides LTE traffic information to the NR scheduler.

S205: The NR scheduler selectively switches the dynamic CRS RM on and off depending on the LTE traffic information.

S206: The NR scheduler provides, as part of DCI, information of whether the dynamic CRS RM has been switched on or off to the NR UE.

Further aspects of how the network node 200 might determine how to combine the static CRS RM with the dynamic CRS RM in the LTE downlink subframe will be disclosed next with reference to the flowchart of FIG. 6.

S301: Check LTE CRS Config: The LTE CRS configuration that comprises the CRS port and CRS location information is checked. This information reveals the number of CRS REs and their location in the PRB time-frequency grid, and hence in the LTE subframe.

S302: Dynamic RM covers all CRS?: The length of the NR PDSCH is checked, and the number of CRS REs that need to be rate-matched is calculated. In case the dynamic RM would cover all LTE CRS REs, then step S303 is entered. Else step S304 is entered.

S303: Select Dynamic RM pattern: If the number of CRS REs is less or equal than the limit for dynamic RM (i.e., 16 REs), then only dynamic RM is sufficient for the configuration. The number of ZP-CSI-RS REs equal to the number of LTE CRS REs is selected for dynamic RM. The ZP-CSI-RS REs are configured in the PRB time-frequency grid, and hence in the LTE subframe, on the location of the LTE CRS REs. If the dynamic RM can cover all the LTE CRS REs in half of the LTE bandwidth, then dynamic RM can also be selected at the expense of LTE performance.

S304: Select Static RM pattern: If the number of LTE CRS REs is greater than the limit for dynamic RM (i.e., 16 REs), then a static RM pattern corresponding to the lowest number of LTE CRS ports is selected. The lowest number of LTE CRS ports corresponds to the lowest fixed number of LTE CRS REs.

S305: Adjust Dynamic RM pattern: If the static RM pattern does not cover all LTE CRS REs, then dynamic RM is employed for the remaining LTE CRS REs, up to its limit.

S306: Dynamic+Static RM cover all CRS? It is checked if the combined dynamic and static RM covers all LTE CRS REs. If yes, step S307 is entered. Else, the static RM pattern corresponding to the next number of LTE CRS ports is selected and steps S304 and S305 are repeated.

S307: Select static+dynamic RM pattern: The combination of static and dynamic RM that can cover all the LTE CRS REs is selected. If the combination of static and dynamic RM can cover all the LTE CRS REs in half of LTE bandwidth, then such a combination can also be selected at the expense of LTE performance.

Further aspects of how the network node 200 might determine when to use dynamic RM, when to use static RM, and when to use a combination of dynamic RM and static RM will be disclosed next with reference to the flowchart of FIG. 7.

S401: The static and dynamic RM configuration as decided in FIG. 6 is configured to the NR UEs.

S402: Any LTE UE Connected?: It is checked whether there are any LTE UEs connected to the LTE cell or not. If yes, step S403 is entered. Else, step S404 is entered.

S403: If there are connected LTE UEs in the LTE cell, the spatial rank reported by each LTE UE to indicate its channel conditions for MIMO transmissions is checked. If the rank of each LTE UE is less than or equal to the static RM pattern corresponding to the number of LTE CRS ports, then step S404 is entered. Else, step S405 is entered.

S404: The NR UEs are scheduled with minimum RM.

S405: The NR UEs are scheduled with RM up to the highest rank reported by the LTE UEs in S405. This can be achieved via enabling dynamic RM through DCI.

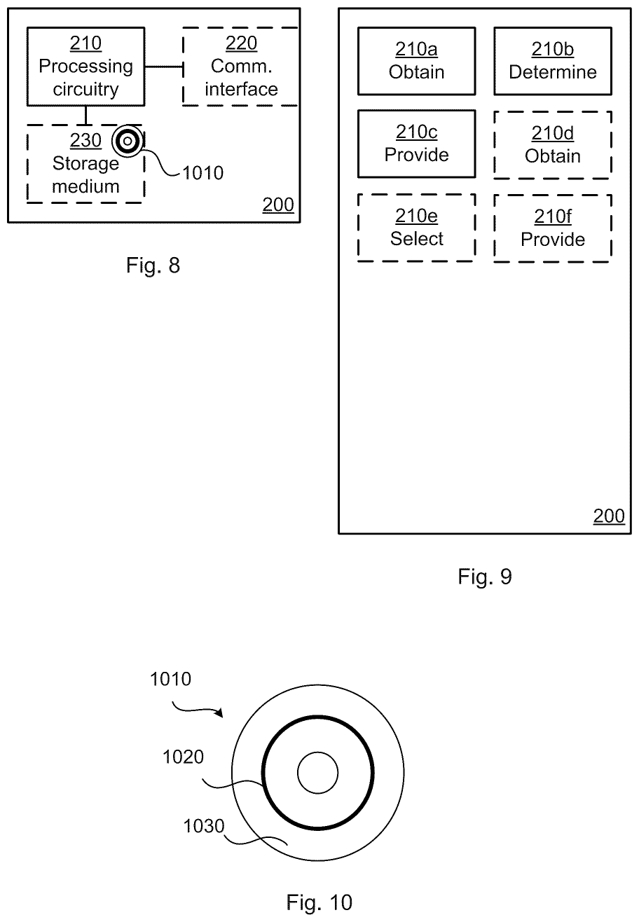

FIG. 8 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1010 (as in FIG. 10), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node 200 may further comprise a communications (comm.) interface 220 at least configured for communications with other entities, functions, nodes, and devices, as in FIG. 1. As such the communications interface 220 may comprise one or more transmitters and receivers, comprising analogue and digital components. The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 9 schematically illustrates, in terms of a number of functional modules, the components of a network node 200 according to an embodiment. The network node 200 of FIG. 9 comprises a number of functional modules; an obtain module 210a configured to perform step S102, a determine module 210b configured to perform step S104, and a provide module 210c configured to perform step S106. The network node 200 of FIG. 9 may further comprise a number of optional functional modules, such as any of an obtain module 210d configured to perform step S108, a select module 210e configured to perform step S110, and a provide module 210f configured to perform step S112.

In general terms, each functional module 210a:210f may in one embodiment be implemented only in hardware and in another embodiment with the help of software, i.e., the latter embodiment having computer program instructions stored on the storage medium 230 which when run on the processing circuitry makes the network node 200 perform the corresponding steps mentioned above in conjunction with FIG. 9. It should also be mentioned that even though the modules correspond to parts of a computer program, they do not need to be separate modules therein, but the way in which they are implemented in software is dependent on the programming language used. Preferably, one or more or all functional modules 210a:210f may be implemented by the processing circuitry 210, possibly in cooperation with the communications interface 220 and/or the storage medium 230. The processing circuitry 210 may thus be configured to from the storage medium 230 fetch instructions as provided by a functional module 210a:210f and to execute these instructions, thereby performing any steps as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 8 the processing circuitry 210 may be distributed among a plurality of devices, or nodes. The same applies to the functional modules 210a:210f of FIG. 9 and the computer program 1020 of FIG. 10.

Some (radio) access network architectures define network nodes (or gNBs) comprising multiple component parts or nodes: a central unit (CU), one or more distributed units (DUs), and one or more radio units (RUs). The protocol layer stack of the network node is divided between the CU, the DUs and the RUs, with one or more lower layers of the stack implemented in the RUs, and one or more higher layers of the stack implemented in the CU and/or DUs. The CU is coupled to the DUs via a fronthaul higher layer split (HLS) network; the CU/DUs are connected to the RUs via a fronthaul lower-layer split (LLS) network. The DU may be combined with the CU in some embodiments, where a combined DU/CU may be referred to as a CU or simply a baseband unit. A communication link for communication of user data messages or packets between the RU and the baseband unit, CU, or DU is referred to as a fronthaul network or interface. Messages or packets may be transmitted from the network node 200 in the downlink (i.e., from the CU to the RU) or received by the network node 200 in the uplink (i.e., from the RU to the CU).

FIG. 10 shows one example of a computer program product 1010 comprising computer readable storage medium 1030. On this computer readable storage medium 1030, a computer program 1020 can be stored, which computer program 1020 can cause the processing circuitry 210 and thereto operatively coupled entities and devices, such as the communications interface 220 and the storage medium 230, to execute methods according to embodiments described herein. The computer program 1020 and/or computer program product 1010 may thus provide means for performing any steps as herein disclosed.

In the example of FIG. 10, the computer program product 1010 is illustrated as an optical disc, such as a CD (compact disc) or a DVD (digital versatile disc) or a Blu-Ray disc. The computer program product 1010 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1020 is here schematically shown as a track on the depicted optical disk, the computer program 1020 can be stored in any way which is suitable for the computer program product 1010.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for configuring static and dynamic CRS rate matching for NR UEs, wherein a spectrum in which the NR UEs are served at least partly overlaps with a spectrum in which LTE UEs are served, wherein the method is performed by a network node, and wherein the method comprises:
obtaining information of LTE CRS port configuration for an LTE downlink subframe;
determining, for the NR UEs, configuration for static and dynamic CRS rate matching in the LTE downlink subframe, wherein how to combine the static CRS rate matching with the dynamic CRS rate matching in the LTE downlink subframe is dependent on the obtained information of the LTE CRS port configuration; and
providing the configuration to the NR UEs.

2. The method according to claim 1, wherein the configuration is provided to the NR UEs as part of a RRC configuration process as the NR UEs establish network connection.

3. The method according to claim 1, wherein the method further comprises:
obtaining LTE traffic information;
selectively switching the dynamic CRS rate matching on and off depending on the LTE traffic information; and
providing, as part of downlink control information, information of whether the dynamic CRS rate matching has been switched on or off to the NR UEs.

4. The method according to claim 3, wherein the LTE traffic information pertains to spatial rank reported by each LTE UE, and wherein the dynamic CRS rate matching is switched off unless a highest reported spatial rank is higher than the corresponding number of ports used for the static CRS rate matching.

5. The method according to claim 4, wherein, when dynamic CRS rate matching is switched on, the NR UEs are scheduled with dynamic CRS RM that corresponds to the highest reported spatial rank reported by the LTE UEs.

6. The method according to claim 1, wherein rateMatchingLTE-CRS is used for the static CRS rate matching.

7. The method according to claim 1, wherein, according to the LTE CRS port configuration, the CRS is transmitted on LTE CRS ports, and wherein the static CRS rate matching is used only for LTE CRS Port 0, or for both LTE CRS Port 0 and LTE CRS Port 1.

8. The method according to claim 1, wherein ZP-CSI-RS is used for the dynamic CRS rate matching.

9. The method according to claim 1, wherein, according to the LTE CRS port configuration, the CRS is transmitted on LTE CRS ports, and wherein the dynamic CRS rate matching is used for all ports except LTE CRS Port 0 where the static CRS rate matching is used.

10. The method according to claim 1, wherein how to combine the static CRS rate matching with the dynamic CRS rate matching in the LTE downlink subframe comprises selecting only a pattern for dynamic CRS rate matching in case dynamic CRS rate matching can cover all LTE CRSs, and else selecting a pattern for both static CRS rate matching and dynamic CRS rate matching.

11. (canceled)

12. The method according to claim 1, wherein, when according to the LTE CRS port configuration, the CRS is transmitted on only CRS Port 0 in each LTE downlink subframe, then the static CRS rate matching is without resource elements, and the dynamic CRS rate matching has resource elements that match the resource elements on which the LTE CRS is transmitted in any, or any combination of, symbols 0, 4, 7, 11 in the LTE downlink subframe.

13. The method according to claim 1, wherein, according to the LTE CRS port configuration, the CRS is transmitted on only CRS Port 0 or on both CRS Port 0 and CRS Port 1 in the LTE downlink subframe.

14-15. (canceled)

16. The method according to claim 1, wherein, when according to the LTE CRS port configuration, the CRS is transmitted on only CRS Port 0, on only CRS Port 0 and one of CRS Port 1, CRS Port 2, CRS Port 3, or on only CRS Port 0, and two of CRS Port 1, CRS Port 2, CRS Port 3, or on all CRS ports in the LTE downlink subframe.

17. The method according to claim 16, wherein the static CRS rate matching is without resource elements, and the dynamic CRS rate matching has resource elements that match the resource elements on which the LTE CRS is transmitted for both CRS Port 0, CRS Port 1, CRS Port 2 and CRS Port 3 in any, or any combination of, symbols 0, 1, 4, 7, 8, 11 in each LTE downlink subframe.

18. The method according to claim 16, wherein the static CRS rate matching has resource elements that match the resource elements on which the LTE CRS is transmitted for CRS Port 0 in any, or any combination of, symbols 0, 4, 7, 11 in the LTE downlink subframe, and the dynamic CRS rate matching has resource elements that match the resource elements on which the LTE CRS is transmitted for CRS Port 1, CRS Port 2 and CRS Port 3 in any, or any combination of, symbols 0, 1, 4, 7, 8, 11 in the LTE downlink subframes.

19. The method according to claim 16, wherein the static CRS rate matching has resource elements that match the resource elements on which the LTE CRS is transmitted for both CRS Port 0 and CRS Port 1 in any, or any combination of, symbols 0, 4, 7, 11 in the LTE downlink subframes, and the dynamic CRS rate matching has resource elements that match the resource elements on which the LTE CRS is transmitted for both CRS Port 2 and CRS Port 3 in any, or any combination of, symbols 1, 8 in the LTE downlink subframes.

20. A network node for configuring static and dynamic CRS rate matching for NR UEs, wherein a spectrum in which the NR UEs are served at least partly overlaps with a spectrum in which LTE UEs are served, the network node comprising processing circuitry, the processing circuitry being configured to cause the network node to:
obtain information of LTE CRS port configuration for an LTE downlink subframe;
determine, for the NR UEs, configuration for static and dynamic CRS rate matching in the LTE downlink subframe, wherein how to combine the static CRS rate matching with the dynamic CRS rate matching in the LTE downlink subframe is dependent on the obtained information of the LTE CRS port configuration; and
provide the configuration to the NR UEs.

21. (canceled)

22. The network node according to claim 20, wherein the configuration is provided to the NR UEs as part of a RRC configuration process as the NR UEs establish network connection.

23. A computer program product comprising a non-transitory computer readable medium storing a computer program for configuring static and dynamic CRS rate matching for NR UEs, wherein a spectrum in which the NR UEs are served at least partly overlaps with a spectrum in which LTE UEs are served, the computer program comprising computer code which, when run on processing circuitry of a network node, causes the network node to:
obtain information of LTE CRS port configuration for an LTE downlink subframe;
determine, for the NR UEs, configuration for static and dynamic CRS rate matching in the LTE downlink subframe, wherein how to combine the static CRS rate matching with the dynamic CRS rate matching in the LTE downlink subframe is dependent on the obtained information of the LTE CRS port configuration; and
provide the configuration to the NR UEs.

24. (canceled)
